(19) United States
(12) Patent Application Publication
(10) Pub. No.: US 2019/0338862 A1
(43) Pub. Date: Nov. 7, 2019

(54) IRRIGATION VALVE

(71) Applicants: Don Duffin, Paul, ID (US); Roger Duffin, Paul, ID (US)

(72) Inventors: Don Duffin, Paul, ID (US); Roger Duffin, Paul, ID (US)

(21) Appl. No.: 16/403,050

(22) Filed: May 3, 2019

Related U.S. Application Data
(60) Provisional application No. 62/666,599, filed on May 3, 2018.

(51) Int. Cl. F16K 31/126; F16K 7/12

(52) U.S. Cl. CPC F16K 31/1266; F16K 31/1268; F16K 7/12

(57) ABSTRACT

What is disclosed is an improved irrigation valve that utilizes an upper diaphragm and a lower diaphragm. The valve has a housing having an intake and a discharge. The lower diaphragm serves to provide a seal between the intake and discharge when the valve is in an off position. In the on position the valve allows fluid flow into the intake and out the discharge. The valve utilizes an upper chamber that when pressurized causes the upper diaphragm to contact and exert pressure on the lower diaphragm, causing the lower diaphragm to close an orifice between the intake and the discharge of the valve housing. The upper diaphragm and the lower diaphragm define a chamber that is preferably vented to atmosphere.

### PRIORITY/CROSS-REFERENCE TO RELATED APPLICATIONS

This application claims the benefit of U.S. Provisional Application No. 62/666,599, filed May 3, 2018, the disclosure of which is incorporated by reference.

### TECHNICAL FIELD

The herein disclosed and claimed inventive concepts generally relate to a valve for use in irrigation such as center pivot irrigation.

### BACKGROUND

Various methods have been utilized to remotely turn a irrigation valve on and/or off. What is needed is an improved system that provided for increased functionality.

### BRIEF DESCRIPTION OF THE DRAWINGS

FIG. 1 is a cutaway view a preferred embodiment of the valve apparatus.

FIG. 2 is a perspective cutaway view of a preferred embodiment of the valve apparatus.

FIG. 3 is a perspective view of a preferred embodiment of the valve apparatus.

FIG. 4 is a cutaway view of a preferred embodiment of the valve apparatus in a closed position.

FIG. 5 is a perspective cutaway view of a preferred embodiment of the valve apparatus in a closed position.

FIG. 6 is an exploded view of a preferred embodiment of the valve apparatus.

FIG. 7 is a perspective cutaway view of a preferred embodiment of the valve in an open position.

FIG. 8 is a cutaway view of a preferred embodiment of the valve in an open position.

FIG. 9 is a perspective partial cutaway view of a preferred embodiment of the valve in an open position.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

In a preferred embodiment the valve of the invention has a housing defining a passageway for fluid flow there through. The housing defines a primary flow path from a housing intake to a housing discharge. The housing intake and housing discharge are separated by a diaphragm seat. The diaphragm seat defines an orifice through which fluid flows from the housing intake to the housing discharge.

A lower diaphragm is positioned and configured to move between an open position and a closed position to seal and open the orifice to flow between the housing intake and the housing discharge. The lower diaphragm is configured to move toward an open position in response to pressure from fluid flow into said intake. The pressure building from fluid flow into the intake forces the lower diaphragm away from the diaphragm seat and allows fluid to flow from the housing intake to the housing discharge. The lower diaphragm is configured to move toward the closed position in response to pressure from an upper diaphragm being asserted on an opposite side of the diaphragm from the pressure asserted by fluid that has entered the housing intake.

The lower diaphragm is configured to seal the orifice from fluid flow there through in a closed position. In the closed position pressure from the upper chamber is exerted on the upper diaphragm, which in turn exerts pressure on the lower diaphragm causing the lower diaphragm to press against the diaphragm seat, sealing the orifice from through flow of fluid. In a preferred embodiment the orifice is a round opening. Correspondingly, in a preferred embodiment the upper and lower diaphragms are in a generally round shape. In a preferred embodiment the upper and lower diaphragms utilize a rigid insert that is configured to provide the contact between the upper diaphragm and the lower diaphragm. In an embodiment the edge of the diaphragm seat can be beveled. In a preferred embodiment the diaphragms are made of a flexible material, such as rubber. The upper and lower diaphragms can be physically separated and constituted independent diaphragms. Alternatively the upper and lower diaphragms can be formed as a single unit, with different sections making up the upper and lower diaphragm.

In a preferred embodiment the valve utilizes an upper chamber that is defined by the upper chamber and a the housing of the valve, or alternatively a bonnet or other cap that forms a portion of the valve housing or attaches to the valve housing to form the valve. An upper chamber port is configured to allow fluid flow into the upper chamber. Pressure build up in the upper chamber moves the upper diaphragm from a first position toward a second position. In moving, the upper diaphragm is configured to impart pressure to the lower diaphragm. The pressure in the upper chamber is greater than the pressure exerted on the lower diaphragm by fluid flowing through the housing, thus causing the lower diaphragm to move to the diaphragm seat and seal the orifice. In a preferred embodiment the effective area of the upper diaphragm is greater than the effective area of the lower diaphragm. The effective area means the area on which fluid pressure acts on each diaphragm. Utilizing a configuration in which the effective area of the upper diaphragm is larger than the effective area of the lower diaphragm allows for a lower pressure fluid to be utilized in the upper chamber to close the valve. However, the effective areas can vary in design with potential for a higher pressure fluid to be utilized in the upper chamber.

In a preferred embodiment a spacer is positioned between the lower diaphragm and the upper diaphragm. In a preferred embodiment the spacer, in combination with the upper diaphragm and lower diaphragm, defines the central chamber. Preferably the spacer is formed as a ring to correspond to the preferred generally circular shapes of the upper diaphragm and the lower diaphragm. In a preferred embodiment the spacer utilizes one or more vent to vent the central chamber to atmosphere. The vent(s) also provide for a notification system in the event that one or all of the diaphragms have failed. In the event of diaphragm failure, fluid will pass into the central chamber and out of the vent hole, thus providing notice that the valve has one or more failed diaphragms.

In a preferred embodiment a spring is positioned in the central chamber and configured to move the upper diaphragm from a second position toward a first position thus expanding the size of the central chamber and reducing the size of the upper chamber when there is no pressure in the upper chamber. The spring serves to vacate at least a portion of the fluid in the upper chamber, providing for an increased expansion area in the upper chamber in the event fluid in the upper chamber freezes. It is thought that the spring will assist, for example, in the winterization of the valve. In a preferred embodiment the spring is positioned between the insert of the lower diaphragm and the insert of the upper diaphragm.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### DETAILED DESCRIPTION OF THE EXEMPLARY EMBODIMENTS

While the presently disclosed technology is susceptible of various modifications and alternative constructions, certain illustrated embodiments thereof have been shown in the drawings and will be described below in detail. It should be understood, however, that there is no intention to limit the claimed technology to the specific form disclosed, but, on the contrary, the presently disclosed and claimed technology is to cover all modifications, alternative constructions, and equivalents falling within the spirit and scope of the inventive concept(s) as defined in the claims. The use of the term “upper” and “lower” refer to the orientation shown in the figures and are not to be construed as limiting in the event of rotation of a device. The term fluid is used generically herein to define a fluid or a gas the flow of which can be regulated with a valve.

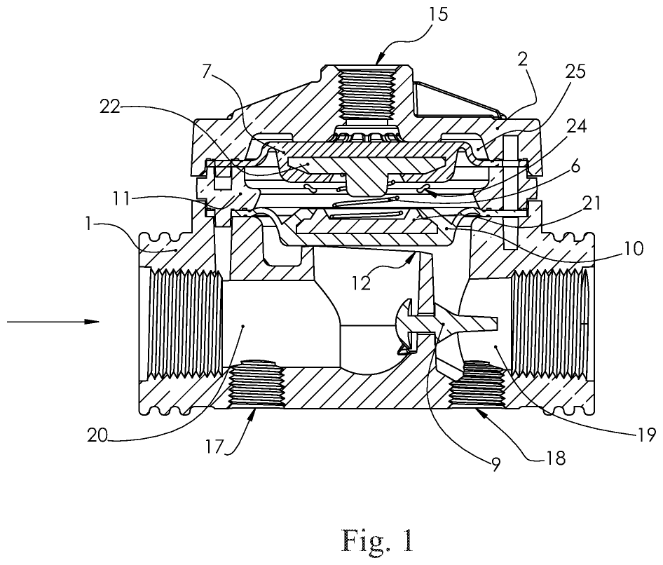

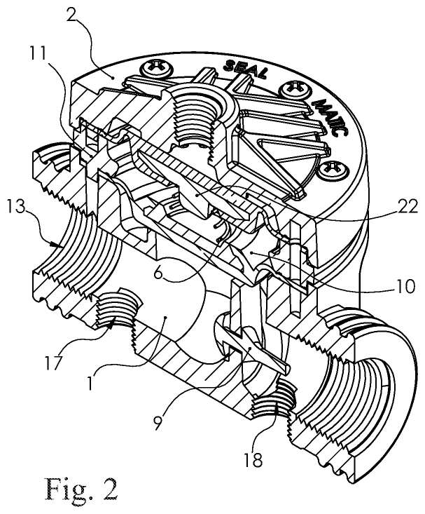

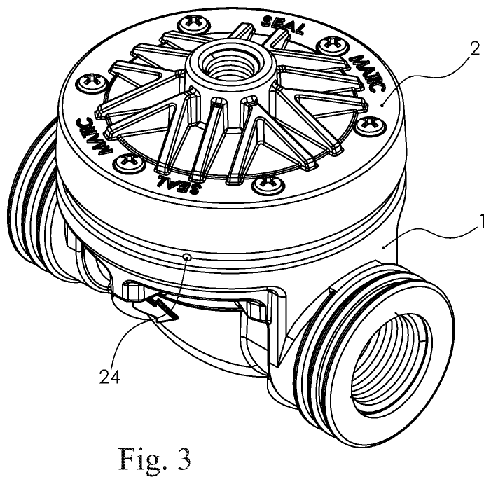

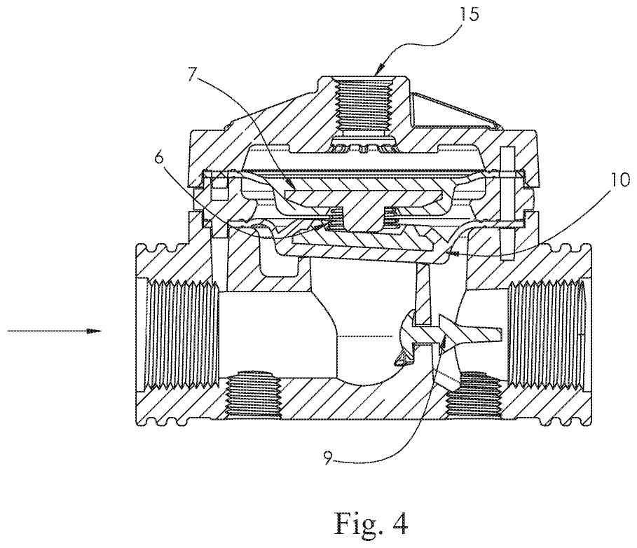

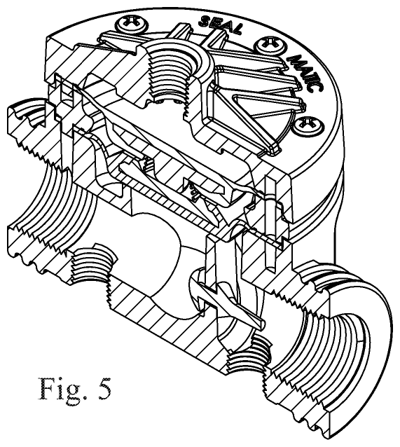

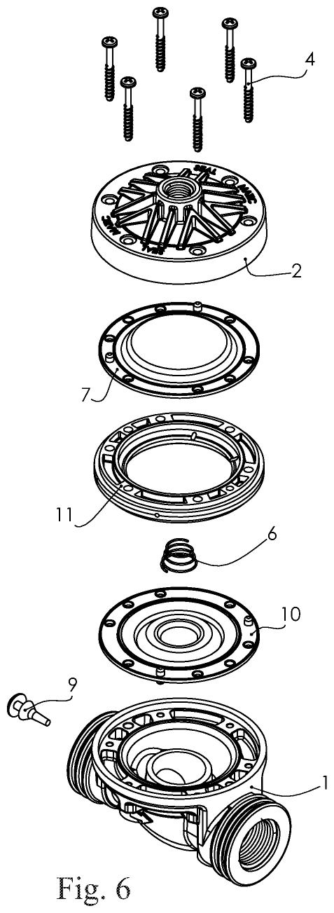

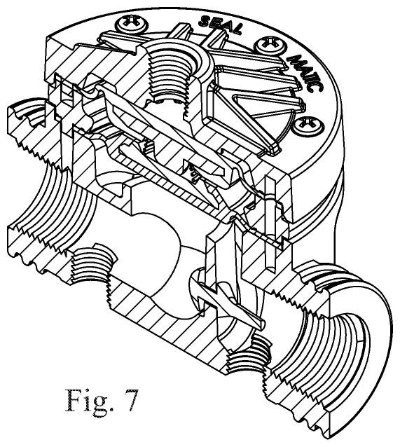

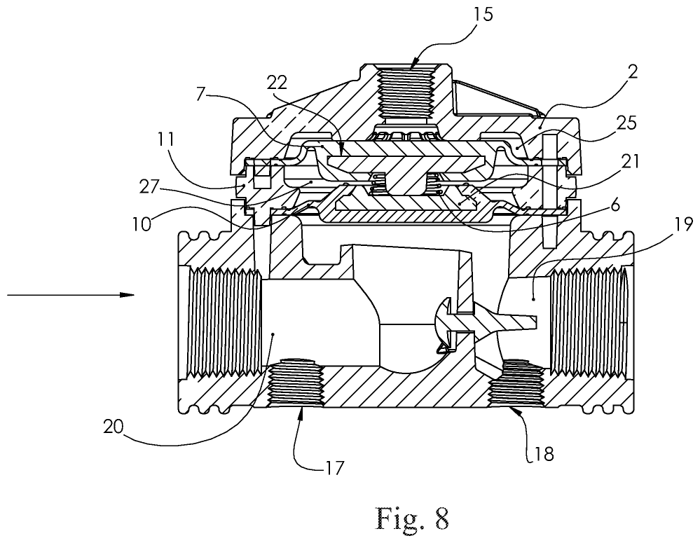

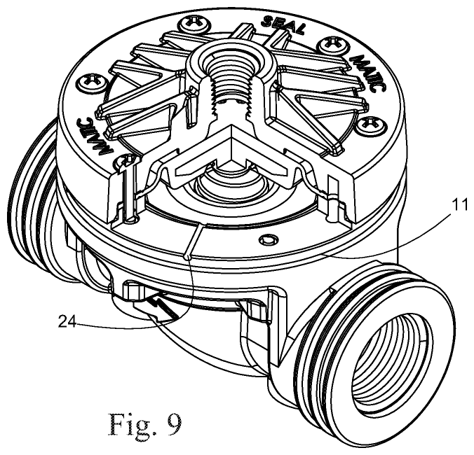

FIGS. 1-9 illustrate a preferred embodiment of the inventive concepts disclosed herein. In a preferred embodiment the complete fluid, the valve utilizes a housing 1 having an intake 20 and discharge 19. The intake and discharge are separated by a valve seat 12. The valve seat provides an orifice for the flow of fluid from the intake to the discharge. In a preferred embodiment, the orifice and seat are circular, however any shape that functions as disclosed herein will suffice. In an embodiment the valve seat is beveled (as shown in the figures) to potentially facilitate the draining of fluid from the intake when the fluid supply is ceased from upstream. In a preferred embodiment the bonnet diaphragm and spacers are attached to the valve housing via bolts 4 or screws, or other fasteners.

A lower diaphragm 10 is configured to move toward and away from the seat in response to pressure on a first side of the diagram and the second side of diagram. The first side of the diagram is configured to seal against the seat in response to pressure from an upper diaphragm 7. In use, when the upper side of the lower diaphragm is free of pressure, fluid inflow in the intake will push the lower diaphragm away from the seat 12 allowing fluid to flow from the intake to the discharge. Pressure applied to the upper part of the lower diaphragm will cause the lower diaphragm to seat against the diaphragm seat and to eliminate the flow of fluid from the intake to the discharge.

In a preferred embodiment, a central chamber 27 separates the lower diaphragm and the upper diaphragm. The chamber is preferably formed by a spacer 11 positioned between the upper diaphragm and the lower diaphragm. Preferably the upper diaphragm and lower diaphragm are circular in structure, with the spacer being a ring like structure between the upper diaphragm and the lower diaphragm to provide a chamber between the upper diaphragm and lower diaphragm. In a preferred embodiment, the central chamber is vented to atmosphere via one or more vents 24. In a preferred embodiment the vents also serve to provide notification if either or both diaphragms have failed in use. If either diaphragm has failed, fluid will typically enter the central chamber and flow or drain out of the vent holes. This will allow for simple diagnosis of a faulty valve. This will be particularly useful in instances in which multiple irrigation valves are installed in a single application, in which it can be difficult to diagnose which valve has a failed.

While referred to herein as being separate upper diaphragms and lower diaphragms, a single structure may be utilized that is configured to provide the same action function as the upper diaphragm and lower diaphragm disclosed herein.

In a preferred embodiment, a bonnet is provided as a cap that is positioned to the upper diaphragm. The bonnet and upper diaphragm form a chamber between the bonnet and upper diaphragm. A bonnet port is configured to allow a fluid or gas, such as air, to flow under pressure to the upper chamber. When fluid enters the upper chamber, the pressure in the upper chamber builds until it exerts pressure on an upper surface of the upper diaphragm. The upper surface of the upper diaphragm has an effective area greater than the effective area on the lower diaphragm on which fluid entering the intake of the valve housing exerts pressure. Thus, less pressure is required of the fluid entering the bonnet port and upper chamber to cause the upper diaphragm to move toward and contact the lower diaphragm and to close the lower diaphragm against the seat. This effectively closes the valve.

In a preferred embodiment, the upper diaphragm and lower diaphragm each utilize an insert that is more ridged than the generally flexible upper diaphragm and lower diaphragm. The inserts allow for pressure to be imparted from the upper diaphragm to the lower diaphragm at the insert. In a preferred embodiment, a spring is positioned in the central chamber. The spring is configured to push the upper diaphragm toward the bonnet port when there is no fluid flow through the bonnet port. This provides for at least a partial evacuation of the upper chamber from fluid. Evacuation of fluid from the upper chamber serves to prevent damage to the valve in the event fluid in the upper chamber freezes by providing expansion space to the upper chamber. In a preferred embodiment, the valve utilizes a drain positioned in a wall of the valve seat between the intake and the discharge. In a preferred embodiment, the drain is an elastomeric mushroom drain configured such that when the fluid supplied to the valve intake is turned off, such as at the end of the growing season, fluid is allowed to the drain from the intake and out to discharge.

In a preferred embodiment, the housing utilizes an upstream port positioned in the intake. The upstream fluid can be ported to, for example, the bonnet port via an actuator. A downstream port 18 is provided such that fluid can be ported to the downstream discharge, such as via an actuator discharge. Preferably the upstream port and downstream port utilize threaded plugs that can be removed to allow access to either port.

A variety of actuators can be utilized to actuate fluid flow into the upper chamber. For example, a solenoid can be utilized to control the actuation of fluid into the chamber. The solenoid can be attached to the bonnet or otherwise to the valve. The solenoid can utilize fluid flow from upstream of the lower diaphragm to fill the upper chamber and actuate closure of the lower diaphragm. The actuation mechanism can be a manual actuation mechanism, such as a manually activated valve, or any other actuation mechanism can be utilized that does not deviate from the mechanism of operation of the valve disclosed herein.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

What is claimed is:

1. A valve, said valve comprising:
a housing, said housing defining a primary flow path from a primary housing intake to a housing discharge, wherein said housing intake and said housing discharge being separated by a diaphragm seat defining an orifice, wherein said orifice is configured for fluid flow between said intake and said discharge;
a lower diaphragm configured to move between an open position and a closed position, wherein said lower diaphragm is configured to move toward said open position in response to pressure from fluid flow into said intake, wherein said lower diaphragm being configured to move toward said closed position in response to pressure from an upper diaphragm, wherein in said closed position said lower diaphragm is configured to seal said orifice, wherein said lower diaphragm and said upper diaphragm define a central chamber between said lower diaphragm and said upper diaphragm; and
an upper chamber port configured to allow fluid flow into an upper chamber, wherein pressure in said upper chamber is configured to move said upper diaphragm from a first position toward a second position, wherein said upper diaphragm is configured to impart pressure to said lower diaphragm in response to pressure in said upper chamber.

2. The valve of claim 1 wherein said valve comprises a spring configured to bias said upper diaphragm to said closed position when said upper chamber is free of pressure.

3. The valve of claim 2 wherein said spring is positioned between said upper diaphragm and said lower diaphragm.

4. The valve of claim 1, wherein said diaphragm seat comprises a beveled edge.

5. The valve of claim 1 wherein said upper diaphragm comprises a rigid upper diaphragm insert configured for contacting said lower diaphragm when pressure is applied to said upper diaphragm from said upper diaphragm chamber.

6. The valve of claim 1 wherein said lower diaphragm comprises a rigid lower diaphragm insert configured for contacting said diaphragm seat.

7. The valve of claim 1 wherein said valve comprises a drain positioned in said wall separating said housing intake and said housing discharge.

8. The valve of claim 7 wherein said drain comprises a mushroom drain.

9. The valve of claim 1 wherein said lower diaphragm and said upper diaphragm are separated by a spacer, wherein said spacer further defines said central chamber.

10. The valve of claim 9 wherein said spacer comprises a ring spacer.

11. The valve of claim 9 wherein said spacer comprises a vent configured to venting said central chamber to atmosphere.

12. The valve of claim 1, wherein said diaphragms comprise a flexible material.

13. The valve of claim 1, wherein said lower diaphragm and said upper diaphragm are connected.

14. The valve of claim 1, wherein said upper chamber port is positioned in a bonnet.

15. The valve of claim 1, wherein an effective area of said first surface of said upper diaphragm is greater than an effective area of said first surface of said lower diaphragm.

16. The valve of claim 1, wherein said orifice is a circular orifice.

17. The valve of claim 1, wherein said upper diaphragm comprises a generally circular shape.

18. The valve of claim 1, wherein said lower diaphragm comprises a generally circular shape.
